(19) United States
(12) Patent Application Publication
(10) Pub. No.: US 2015/0276515 A1
(43) Pub. Date: Oct. 1, 2015

(54) OPERATION INPUT DEVICE

(71) Applicant: DENSO CORPORATION, Kariya-city (JP)

(72) Inventors: Syunsuke SHIBATA, Nishio-city (JP); Norio SANMA, Okazaki-city (JP); Sei IGUCHI, Okazaki-city (JP)

(21) Appl. No.: 14/645,511

(22) Filed: Mar. 12, 2015

(30) Foreign Application Priority Data
Apr. 1, 2014 (JP) 2014-75692

(51) Int. Cl. G01L 1/22; G06F 3/041

(52) U.S. Cl. CPC G01L 1/22; G06F 3/0414; G06F 3/0416

(57) ABSTRACT

An operation input device has an improved position detection accuracy for detecting a position of an operation force by forming a wide portion on one end of an operation unit at a periphery thereof and by fixedly disposing, on a stay, a narrow portion on an opposite end of the operation unit, among which the wide portion protrudes in an in-parallel direction of an operation surface of the operation unit.

### CROSS REFERENCE TO RELATED APPLICATION

The present application is based on and claims the benefit of priority of Japanese Patent Application No. 2014-075692, filed on Apr. 1, 2014, the disclosure of which is incorporated herein by reference.

### TECHNICAL FIELD

The present disclosure generally relates to an operation input device for an input of a controlling operation that controls, for example, a vehicular navigation apparatus, an air conditioning apparatus, or an audio-visual apparatus.

### BACKGROUND INFORMATION

A conventional operation input device is an applied force detector which has an operation unit disposed on a shaft, a strain body in a board shape to be elastically deformed according to an applied force that is applied to the operation unit, and at least four strain detection elements for detecting the deformation of the strain body, as disclosed in a patent document 1 (i.e., Japanese Patent Laid-Open No. 2010-181398), for example. Further, the four strain detection elements are disposed on one strain body, that is, on one disposition surface of the body, and the strain body and the shaft of the operation unit are connected by a connection body and have one body.

The operation input device in the patent document 1 transmits the applied force on the operation unit to the disposition surface that bears the strain detection elements of the strain body via the connection body, and the applied force is detected based on the output signal from the strain detection elements. More practically, the applied force is detected as an x axis operation force along the x axis, a y axis operation force along the y axis, and/or a z axis operation force along the z axis, as well as a moment about the z axis, when the x/y axes are defined as in-parallel axes along an operation surface of the operation unit and the z axis is defined as a perpendicular axis perpendicular to the operation surface.

However, the device in the patent document 1 is not capable of accurately detecting a position of the operation force when the operation force is a combination of multiple axial forces. That is, depending on the operation of the operation unit by the operator, the applied force may be a combination of an in-parallel force that is in parallel with the operation surface and a perpendicular force that is perpendicular to the operation surface. In such case, the position of the operation force is not accurately detected by the device in the patent document 1.

### SUMMARY

It is an object of the present disclosure to provide an operation input device that has an improved accuracy in detecting the position of the operation force.

For a resolution of the above-described problem, the present disclosure provides the following technical solution. In an aspect of the present disclosure, an operation input device includes an operation unit having an operation surface, a strain body elastically deformed by a force applied to the operation unit, a connection body connecting the operation unit with the strain body, the connection body being at least partially deformed by the force applied to the operation unit, at least four strain gauges respectively gauging a deformation of the strain body, an operation force calculator calculating the force applied to the operation unit based on a gauged strain by each of the at least four strain gauges, and a stay attached to the operation unit. A wide portion of the operation unit is disposed along a periphery of the operation surface and protrudes in a direction that is generally in parallel with the operation surface and a narrow portion of the operation unit is fixedly disposed on the stay. The wide portion is positioned on a side of the operation unit adjacent to the operation surface, and the narrow portion is positioned away from the operation surface on an opposite side of the operation unit relative to the operation surface and the wide portion.

In another aspect of the present disclosure, the operation unit has a sidewall that narrows from the wide portion toward the narrow portion.

In yet another aspect of the present disclosure, the connection body is formed from a flat spring.

In still another aspect of the present disclosure, the operation unit has a cylindrical shape.

According to the above disclosure, when the operation unit is operated in the in-parallel direction that is in parallel with the operation surface, the wide portion of the operation unit receives the operation force of such operation. In such structure, the narrow portion of the operation unit is fixedly disposed on the stay, a component of the operation force in a perpendicular direction, i.e., a direction from the operation surface toward the narrow portion. Further, a component of the operation force in an opposite direction, i.e., a direction opposite to the one described in the above is also invalidated/canceled (i.e., the component of the operation force in a direction from the narrow portion toward the operation surface). Therefore, the operation force is not a combination (i.e., mixture) of the in-parallel force and the perpendicular force. Thus, the position of the operation force applied to the operation unit in parallel with the operation surface is accurately detected, due to the above structure that cancels the perpendicular force (i.e., a perpendicular force component).

The numerals in the parentheses represent relationships between the claimed parts of the operation input device in the summary description in the above and the various practical components in the embodiment in the following.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of a navigation apparatus and an operation input device in a first embodiment of the present disclosure;

FIG. 2A is a sectional view and a plan view, which shows a connection body, a strain body, and a strain gauge, of the operation input device of the present disclosure;

FIG. 2B is a sectional view and a plan view, which shows a connection body, a strain body, and a strain gauge, of the operation input device of the present disclosure;

FIG. 3A is a model diagram of a load on a strain body when a z axis force is applied thereon;

FIG. 3B is a model diagram of a load on a strain body when a z axis force is applied thereon;

FIG. 4A is a model diagram of a load on the strain body when a y axis force is applied thereon;

FIG. 4B is a model diagram of a load on the strain body when a y axis force is applied thereon;

FIG. 5A is a table diagram of a change of resistance of each of strain bodies that are shown in FIGS. 3A and B;

FIG. 5B is a schematic diagram of a bridge circuit formed by the strain bodies;

FIG. 6A is an illustration of how position coordinates of a perpendicular force are calculated when a perpendicular force is applied to an outer face of an operation panel;

FIG. 6B is an illustration of how position coordinates of a perpendicular force are calculated when a perpendicular force is applied to an outer face of an operation panel;

FIG. 7A is an illustration of how to detect a force along an x, y, or z axis, and how to detect a moment about the z axis;

FIG. 7B is an illustration of how to detect a force along an x, y, or z axis, and how to detect a moment about the z axis;

FIG. 7C is an illustration of how to detect a force along an x, y, or z axis, and how to detect a moment about the z axis;

FIG. 7D is an illustration of how to detect a force along an x, y, or z axis, and how to detect a moment about the z axis; and

FIG. 8 is a sectional view of a connection body in a second embodiment of the present disclosure.

### DETAILED DESCRIPTION

Embodiments of the present disclosure are described based on the drawings. In each of the embodiments, the same numerals may be borrowed from the preceding embodiment(s), and the description of the same parts may be not repeated. In each of the embodiments, the configuration may be fully described or partially described, in which case a non-described portion of the configuration may be borrowed from the preceding embodiment(s). The combination of the embodiments or parts of the embodiments should be permitted when not only it is explicitly described but also it is only implicitly described, unless otherwise indicated or unless any hindrance factor prevents the combination.

### First Embodiment

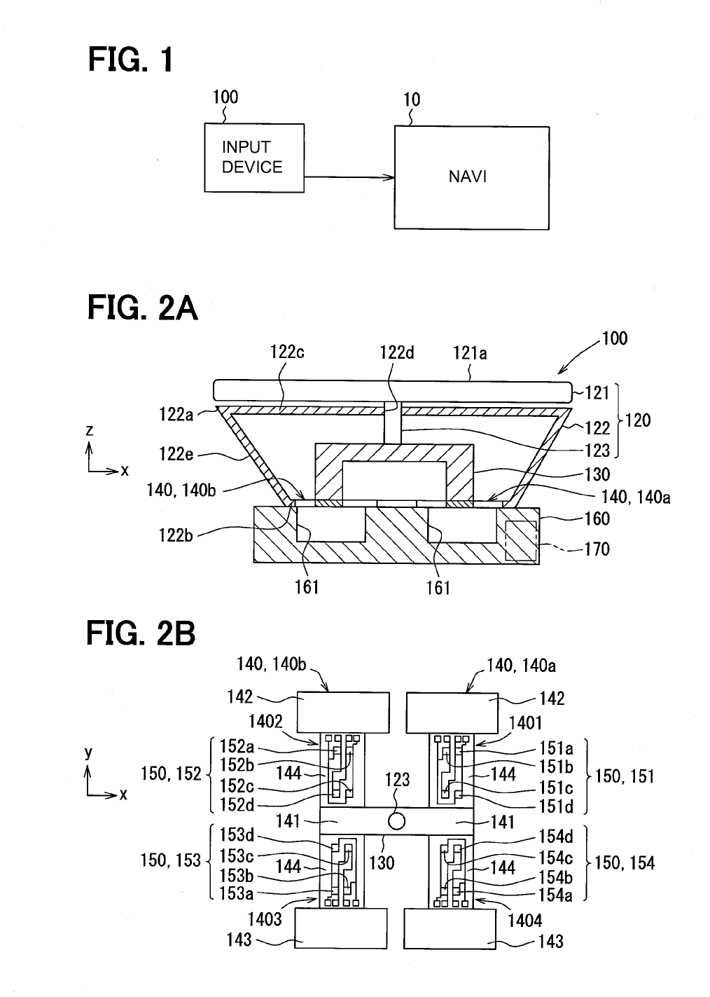

A configuration of an operation input device 100 in the first embodiment of the present disclosure is described with reference to FIGS. 1 to 5.

As shown in FIG. 1, the operation input device 100 is a device which performs an operation input for operating an in-vehicle navigation device 10, for example. The operation input device 100 may also be used for an input to various apparatuses, e.g., an air-conditioner and audio equipment, other than the above-mentioned navigation device 10.

As shown in FIG. 2, the operation input device 100 is provided with an operation unit 120, a connection body 130, a strain body 140, a strain gauge 150, a stay 160, a signal processor 170 and the like. The connection body 130, the strain body 140, and the strain gauge 150 are disposed inside the operation unit 120.

The operation unit 120 includes an operation panel 121, a dial 122, and a shaft 123. The operation panel 121 is a circular board shape member. The outer face of the operation panel 121 (i.e., an upper/top face; see FIG. 2A) is an operation surface 121a. The operation panel 121 is a so-called touch panel for receiving a finger operation (e.g., a touch, a drag, etc.) of an operator/user.

The operation panel 121 is defined in a coordinate system which uses x, y, z axes for defining position coordinates of a space around the operation input device 100. That is, a center point of the operation panel 121 is an origin of the coordinate system, with the x axis and y axis extending in parallel with the operation surface 121a, and the z axis extends perpendicular to the surface 121a. Those axes may also be associated with the vehicle orientation, such as the x axis extending in a right-left direction of the vehicle, with the y axis extending in a front-rear direction and the z axis in a height direction. The operation panel is used for receiving a z axis operation force (i.e., an input of a perpendicular force) at (x, y) position coordinates when the operator's fingertip touches, drags on or the operation panel 121.

The dial 122 is a flat cylindrical member, and is disposed to face an opposite side of the operation surface 121a of the operation panel 121. The dial 122 (i.e., the operation unit 120) may be an operation “knob” that is grabbed or pinched with fingers by an operator, and may be pulled, tilted or twisted/rotated along and about each of those axes, for an operation input. One side of the dial 122 facing the operation panel 121 is a shutting surface 122c which shuts an opening of the cylinder shape of the dial 122. At the center of the shutting surface 122c, a shaft hole 122d is bored. Further, an opposite side of the dial opposite to the shutting surface 122c is a narrow portion 122b, which is an opening. The edge of the opening of the narrow portion 122b is fixed onto the stay 160.

The dial 122 has a sidewall 122e that has a “negative” slope from one side to the other, i.e., from a shutting surface 122c side toward the narrow portion 122b, as shown in FIG. 2A. That is, when the sidewall 122e comes close to the narrow portion 122b, the diameter of the sidewall 122e decreases, which forms an upside-down trapezoid shape cross section. In other words, the sidewall 122e of the dial 122 narrows from the wide portion 122a to the narrow portion 122b. Therefore, the corner of the dial 122 on a shutting surface 122c side has an acute angle. The corner may thus be designated as a wide portion 122a protruding in an “extending direction” along which the operation surface 121a extends. The extending direction may also be called as an in-parallel direction, which is in parallel with the operation surface 121a.

The shaft 123 is a rod member which has a substantially circular cross section. One end of the shaft 123 is connected to a center portion surface on a dial 122 side of the operation panel 121. The shaft 123 is inserted into the shaft hole 122d of the dial 122, and is connected to an inner surface of the shaft hole 122d. That is, the operation panel 121, the dial 122, and the shaft 123 are integrated to have one united body, to be serving as the operation unit 120. An opposite end of the shaft 123 opposite to the operation panel 121 extends toward a center portion of an inside space of the dial 122.

The connection body 130 connects the operation unit 120 and the strain body 140 mentioned later, and it serves as a connecting member that is at least partially deformed by a force that is applied to the operation unit 120. The connection body 130 is, as shown in FIG. 2A, an upside-down U letter shape in its cross section, and is positioned in between the other end of the shaft 123 and the narrow portion 122b of the dial 122. The “bottom” of the U letter shape of the connection body 130 is connected to the shaft 123. Further, two tops (i.e., edges) of the U letter shape of the connection body 130 are respectively connected to the strain body 140.

The strain body 140 which is connected to the connection body 130 is a board shape member of an I letter shape, and is elastically distorted and strained by a force that is applied to the operation unit 120. The strain body 140 is provided in two pieces, i.e., is formed as a first strain body 140a, and a second strain body 140b. The two strain bodies 140a and 140b have the same configuration, extending in parallel with each other along a perpendicular direction that is perpendicular to a virtual plane that includes the U letter shape of the connection body 130. Both strain bodies 140a and 140b have a central stationary portion 141, side ends 142 and 143, and a gauge holder 144.

The central stationary portion 141 is positioned at a center of the I letter shape in the longitudinal direction, and the side ends 142, 143 are narrow portions on both ends of the I letter shape. Further, the central stationary portion 141 on each of the strain bodies 140a, 140b is fixed to the tops of the U letter shape. Further, the side ends 142, 143 are respectively fixed onto the stay 160.

The gauge holder 144 is formed at a position between the central stationary portion 141 and each of the side ends 142 and 143, and serves as a region where the strain gauge 150 which is mentioned later is positioned. In each of the first and second strain bodies 140a and 140b, two gauge holders 144 are provided, resulting in four holders 144 in total. As shown in FIG. 2B, two regions corresponding to two gauge holders 144 of the first strain body 140a are hereafter designated as a first region 1401 and a fourth region 1404. Similarly, two regions corresponding to two gauge holders 144 of the second strain body 140b are hereafter designated as a second region 1402 and a third region 1403.

The strain gauge 150 is a detector for detecting a distortion or a strain of the strain body 140 which is caused by the distortion of the connection body 130 due to the operation force applied to the operation unit 120. Four strain gauges 150 are provided respectively in a corresponding manner for each of the four gauge holders 144 on the strain bodies 140a and 140b. The four strain gauges 150 are designated as a first strain gauge 151, a second strain gauge 152, a third strain gauge 153, and a fourth strain gauge 154.

The first strain gauge 151 is positioned in the first region 1401 of the first strain body 140a. The second strain gauge 152 is positioned in the second region 1402 of the second strain body 140b. The third strain gauge 153 is positioned in the third region 1403 of the second strain body 140b. The fourth strain gauge 154 is positioned in the fourth region 1404 of the first strain body 140a.

Each of the strain gauges 151 to 154 has four strain gauge elements, respectively, as shown in FIG. 2B. That is, the first strain gauge 151 has strain gauge elements 151a, 151b, 151c, and 151d. Similarly, the second strain gauge 152 has strain gauge elements 152a, 152b, 152c, and 152d. Similarly, the third strain gauge 153 has strain gauge elements 153a, 153b, 153c, and 153d. Similarly, the fourth strain gauge 154 has strain gauge elements 154a, 154b, 154c, and 154d.

In the present embodiment, as each of the strain gauge elements 151a-151d and 152a-152d and 153a-153d and 154a-154d of the strain gauges 151 to 154, the distortion detecting element (i.e., a strain gage) is used, in which the electric resistance value changes according to the distortion of the strain body 140 (i.e., the first and second strain bodies 140a and 140b), for example.

In each of the strain gauges 151 to 154, a bridge circuit as shown in FIG. 5B is formed by the four strain gauge elements, i.e., by the elements 151a-151d, 152a-152d, 153a-153d, and 154a-154d. The voltage (Vout) of the midpoint of each bridge circuit is output to the signal processor 170, respectively, which is mentioned later.

The stay 160 is a base, or a pedestal, for holding the narrow portion 122b of the operation unit 120 and each of the strain bodies 140a, 140b, which may be formed by a board shape member. The upper face of the stay 160 on which the strain bodies 140a/b are disposed has two grooves 161 that extend along the I letter shape of those bodies 140a/b. Further, each of the I letter shape grooves 161 is bridged, or covered, by the I letter shape strain body 140a or 140b. That is, the side ends 142, 143 of the strain body 140a, for example, are respectively fixed on the upper face of close-to-end portions of the stay 160, which are respectively close to both ends of the I letter shape grooves 161. In other words, the strain bodies 140a/b do not contact/touch the stay 160 except for the side ends 142, 143.

The signal processor 170 is an operative force calculation circuit disposed on the stay 160. The signal processor 170 calculates the magnitude of the operation force applied to the operation panel 121 and the position of the operation force (i.e., the operation position) based on the output voltage from each of the strain gauges 151 to 154. The signal processor 170 further calculates the direction (i.e., x, y, z axis directions) and magnitude of the operation force which is applied to the dial 122, and also calculates the direction and magnitude of a moment of such operation force along a circumference direction about the z-axis. Then, based on the calculation result, the display operation of the navigation device 10 is controlled. For example, a selection of menu icons, and an OK operation for determining the selection, as well as a screen switching between a position display of the own vehicle and a destination guidance on the map, map scrolling are enabled according to the calculation of the position and direction of the operation force.

Next, the operation of the operation input device 100 constituted as mentioned above is described in detail.

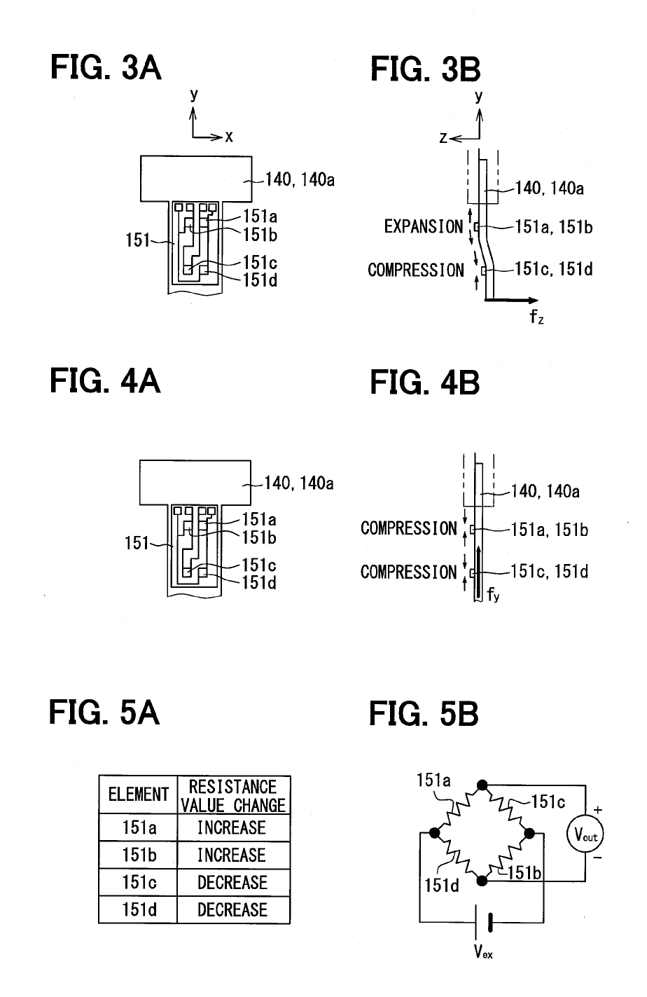

As shown in FIGS. 3A/B and FIGS. 4A/B, operation forces (fz, fy, etc.) are transmitted to the strain body 140 (140a, 140b) via the connection body 130 when the operation panel 121 or the dial 122 is operated by an operator. Then, according to the applied force, the strain body 140 is either pulled/expanded or pressed/compressed, and an expansive or compressive deformation is caused therein. As shown in FIG. 5A, the resistance value of the distortion detecting element increases when the element-having region is pulled or expanded (i.e., 151a, 151b of FIGS. 3A/B), or decreases when the element-having region is compressed (i.e., 151c, 151d of FIGS. 3A/B, 151a-151d of FIGS. 4A/B) Thus, an output voltage value of the bridge circuit changes when the resistance value of each of the strain gauge elements 151a to 151d changes.

According to the position, the direction and the magnitude of the operation force applied to the operation panel 121 or the dial 122, the output voltage values from the strain gauges 151 to 154 differ, respectively. Therefore, the signal processor 170 can recognize the operation force that is applied to the operation panel 121 or the dial 122, i.e., the position, the direction and the magnitude of the applied operation force, based on the output voltage value in each of the strain gauges 151 to 154.

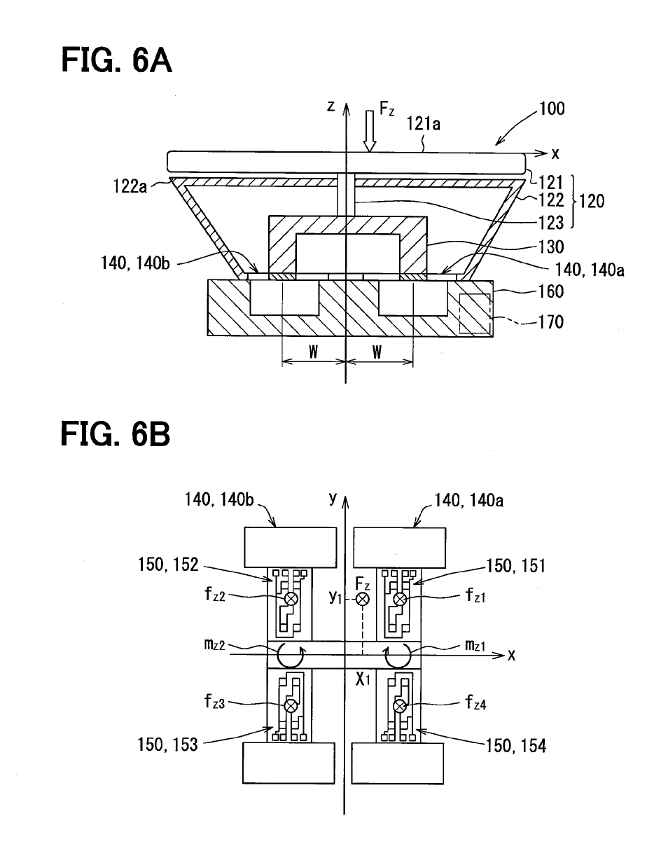

Hereafter, with reference to FIGS. 6A/B, and 7A/B/C/D, a method of recognizing the different operation forces from different operations is described.

1. When the operation force is applied to the operation panel 121 along the z axis

As shown in FIGS. 6A/B, when an operation force Fz along the z axis is applied to the operation panel 110 by a touch operation (i.e., a tap) of the operator at position coordinates of x1, y1, the force along the z axis transmitted to each of the strain gauges 151 to 154 is sensed as fz1, fz2, fz3, and fz4, respectively, and the force Fz is thus represented by an equation 1.

Fz=fz1+fz2+fz3+fz4 (Equation 1)

A moment Fx·x1 about the y axis by the operation force Fx is represented by an equation 2 when a distance along the x axis from the origin to the strain gauges 151 and 154 and a distance along the x axis from the origin to the strain gauges 152 and 153 are designated as w, respectively.

Fx·x1=(fz1+fz4)·w−(fz2+fz3)·w (Equation 2)

A moment Fx·y1 about the x axis by the operation force Fx is represented by an equation 3 when a moment about the x axis according to the difference between the force fz1 and the force fz4 is designated as mz1, and a moment about the x axis according to the difference between the force fz2 and the force fz3 is designated as mz2.

Fx·y1=mz1+mz2 (Equation 3)

Therefore, based on the equation 1 and the equation 2, an equation 4 is composed.

x1={(fz1+fz4)−(fz2+fz3)}·w/(fz1+fz2+fz3+fz4) (Equation 4)

Further, based on the equation 1 and the equation 3, an equation 5 is composed.

y1=(mz1+mz2)/(fz1+fz2+fz3+fz4) (Equation 5)

That is, the position (x, y coordinate positions) of the applied operation force can be grasped based on the forces fz1 to fz4 obtained from each of the strain gauges 151 to 154 and the moments mz1, mz2.

2. When the operation force is applied to the operation unit 120 along each of x, y, z axes and about the z axis

(1) The Operation Force Along the x Axis

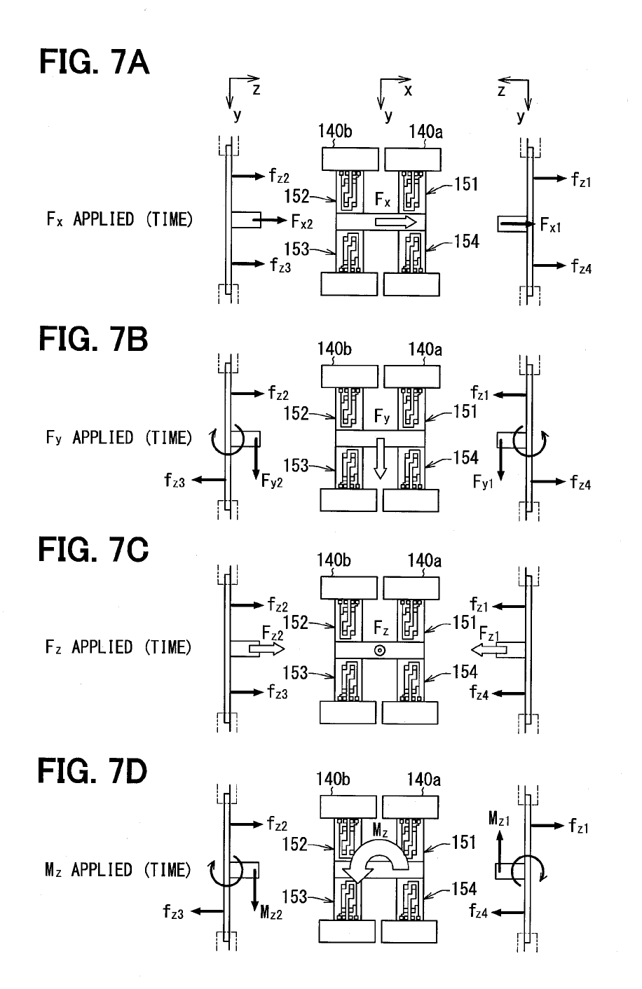

As shown in FIG. 7A, when the operation force Fx along the x axis is applied to the operation unit 120, a force Fx1 acts on the central part (i.e., on the central stationary portion 141) of the first strain body 140a in the minus direction of the z axis. Thereby, the forces fz1 and fz4 act on the first strain gauge 151 and the fourth strain gauge 154 in the minus direction of the z axis, respectively.

Further, a force Fx2 acts on the central part (i.e., the central stationary portion 141) of the second strain body 140b in the plus direction of the z axis. Thereby, the forces fz2 and fz3 act on the second strain gauge 152 and the third strain gauge 153 in the plus direction of the z axis, respectively.

(2) The Operation Force Along the y Axis

As shown in FIG. 7B, when the operation force Fy along the y axis is applied to the operation unit 120, a force Fy1 acts on the central part (i.e., the central stationary portion 141) of the first strain body 140a in the minus direction of the y axis. Then, due to a moment that is caused by the force Fy1, the force fz1 acts on the first strain gauge 151 in the plus direction of the z axis, and the force fz4 acts on the fourth strain gauge 154 in the minus direction of the z axis.

Further, the force Fy2 acts on the central part (i.e., the central stationary portion 141) of the second strain body 140b in the minus direction of the y axis. Then, due to a moment that is caused by the force Fy2, the force fz2 acts on the second strain gauge 152 in the plus direction of the z axis, and the force fz3 acts on the third strain gauge 153 in the minus direction of the z axis.

(3) The Operation Force Along the z Axis (i.e., a Pull-Up or a Press-Down of the Operation Unit 120)

As shown in FIG. 7C, when the operation force Fz along the z axis (i.e., in a pull-up direction or in a press-down direction: an example of FIG. 7C is a pull-up case) is applied to the operation unit 120, a force Fz1 acts on the central part (i.e., the central stationary portion 141) of the first strain body 140a in the plus direction of the z axis. Thereby, the forces fz1 and fz4 act on the first strain gauge 151 and the fourth strain gauge 154 in the plus direction of the z axis, respectively.

Further, the force Fx2 acts on the central part (i.e., the central stationary portion 141) of the second strain body 140b in the plus direction of the z axis. Thereby, the forces fz2 and fz3 act on the second strain gauge 152 and the third strain gauge 153 in the plus direction of the z axis, respectively.

(4) The Operation Force About the y Axis

As shown in FIG. 7D, when the operation force Mz about the z axis is applied to the operation unit 120, a force Mz1 acts on the central part (i.e., the central stationary portion 141) of the first strain body 140a in the plus direction of the y axis. Then, due to a moment that is caused by the force Mz1, the force fz1 acts on the first strain gauge 151 in the minus direction of the z axis, and the force fz4 acts on the fourth strain gauge 154 in the plus direction of the z axis.

Further, a force Mz2 acts on the central part (i.e., the central stationary portion 141) of the second strain body 140b in the minus direction of the y axis. Then, due to a moment that is caused by the force Mz2, the force fz2 acts on the second strain gauge 152 in the plus direction of the z axis, and the force fz3 acts on the third strain gauge 153 in the minus direction of the z axis.

Based on the above descriptions (1) to (4), the combination of force directions (i.e., plus or minus direction) regarding the forces fz1 to fz4 that are generated in each of the strain gauges 151 to 154 is different for each of the operation forces Fx, Fy, Fz, and Mz. Therefore, based on such different combinations of the force directions, the operation of the operation unit 120 is detected and recognized, in terms of which one of the three axes the operation force is oriented, and in terms of whether the operation force about the z axis is caused.

3. When the operation force is applied to the operation unit 120 in the in-parallel direction that is in parallel with the operation surface 121a

When the operation unit 120 (i.e., the dial 122) is operated along the operation surface 121a, i.e., along the x axis or along the y axis, or along a direction that is arbitrarily composed from x and y axes components, the operation force is mainly received by the wide portion 122a of the operation unit 120 (i.e., since the wide portion 122a generally defines an outline of the operation unit 120 at the position close to the operation panel 121).

When the operation force is received as the in-parallel operation force by the wide portion 122a, such an operation force is sensed as a force in/along the x-y plane which includes no perpendicular force component, because the narrow portion 122b of the operation unit 120 is fixed on the stay 160. That is, the fixation of the narrow portion 122b on the stay 160 cancels a force component along a perpendicular direction, which may be a direction from the operation surface 121a toward the narrow portion 122b, or a direction from the narrow portion 122b toward the operation surface 121a. Such a force component may also be designated as a force in the plus direction of the z axis, or a force in the minus direction of the z axis.

That is, in other words, a generally in-parallel operation force is isolated to be a purely in-parallel operation force, due to the structure of the operation unit 120 described above, which eliminates the z axis operation force components, either in the positive direction or in the negative directions. Therefore, the combination of the in-parallel force and the perpendicular force, or the corruption of the in-parallel force by the perpendicular force, is prevented. Therefore, an accurate operation position of the operation force is detected.

### Second Embodiment

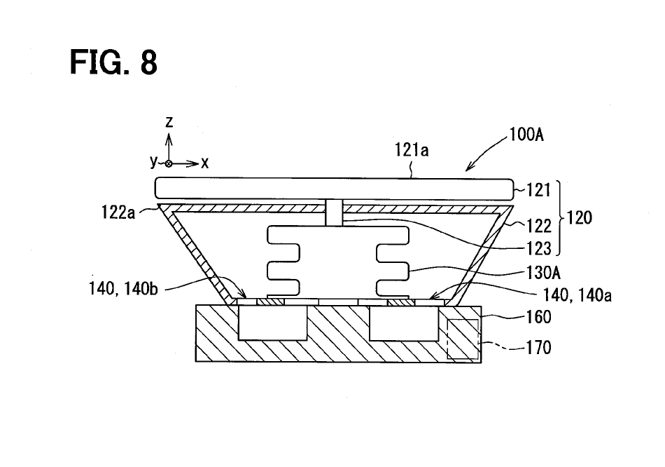

An operation input device 100A of the second embodiment is shown in FIG. 8. In the present embodiment, the shape of the connection body 130 is changed from the one in the above-described first embodiment, to make a connection body 130A.

The connection body 130A is formed with a single flat spring that is bent two or more times. The flat spring may be formed, for example, by a press work. A part of the connection body 130A is formed as a thin board shape. The number of the bending of the body 130A as well as the x/y axis dimension of the flat spring and the height of the after-bending flat spring along the z axis are respectively predetermined together with other conditions.

The connection body 130A provides, other than a holding function that fixedly holds the operation unit 120, and the strain body 140, an operation force transmitting function that transmits, to the strain body 140, the operation force applied to the operation unit 120.

In particular, the moment about the z axis may be transmitted in an amplified manner to the strain body 140 when a part of the connection body 130A is made thinner. That is, the amount of deformation of the strain body 140 for the same twisting moment may be increased in such manner.

By providing the connection body 130A as the flat spring, the connection body 130A serves as a connection body as well as serving as an elastic body. By having an elastic body, the operation unit 120 may be more easily moved/displaced by the operation force, thereby making it easier for the operation unit 120 to detect the operation force from the operator.

Further, by folding/bending the flat spring in many times, i.e., by the adjustment of the number of foldings and the dimensions of the folded portions, the displacement (i.e., move) of the operation unit 120 by the x axis force and the displacement of the same unit 120 by the y axis force may be substantially equated. That is, a natural and nonbiased operation feeling of the operation unit 120 may be realized in such manner.

### Other Embodiments

Although the present disclosure has been fully described in connection with preferred embodiment thereof with reference to the accompanying drawings, it is to be noted that various changes and modifications become apparent to those skilled in the art.

For example, the negative slope of the operation unit 120, i.e., the sidewall 122e of the dial 122 is negatively inclined to form the wide portion 122a, in the above embodiment may be changed to a different form. That is, the dial 122 may be made as a straight cylinder, having a constant diameter cross section, and only a narrow portion of the dial 122 close to the operation panel 121 may be made to protrude along the operation panel 121 as a wide portion. In other words, the sidewall 122e of the dial 122 narrows from the wide portion 122a to the narrow portion 122b.

Although the strain body 140 may be formed as two separate parts 140a and 140b respectively having the I letter shape in the above, the strain body 140 may be made in one body, i.e., as a press work of one board for having an O letter shape. Further, the four strain gauges 151 to 154 may be formed in one body, i.e., as one strain body on one board. Alternatively, the four gauges 151 to 154 may be separately disposed on respectively different four strain bodies.

Further, the operation surface 121a of the operation panel 121 may have grooves, concaves, convexes, and the like. The grooves on the surface 121a along the x axis may be made to stabilize a slide operation by the finger, for example. Further, the concave/convex at the center of the surface 121a may allow the operator to sense the whereabout/position of the finger in a tactile manner on the panel 121, without looking at the operating finger. That allows, in other words, an easy operation of the operation input device 100 for various controls based on the tactile feedback of a reference position from the finger/hand.

Further, in the above embodiments, each of the strain gauges 151 to 154 of the strain gauge 150 is made from four strain gauge elements 151a-151d, 152a-152d, 153a-153d, and 154a-154d, respectively. However, each of the strain gauges 151 to 154 may be made from only one distortion detecting element. That is, four strain gauges 150 may suffice at the least.

Further, the x/y/z axes respectively defined as the lateral/longitudinal/height directions of the vehicle may be differently defined, depending on the situations. That is, according to the installation position of the operation input devices 100 and 100A, the x/y/z axes may be associated with the lateral/height/longitudinal directions relative to the vehicle, for example.

Further, the shape of the operation unit 120 (i.e., of the operation panel 121) is not restricted to the cylindrical shape. That is, the shape of the operation unit 120 and/or the operation panel 121 may be a polygonal shape or the like.

Such changes, modifications, and summarized schemes are to be understood as being within the scope of the present disclosure as defined by appended claims.

What is claimed is:

1. An operation input device comprising:
an operation unit having an operation surface;
a strain body elastically deformed by a force applied to the operation unit;
a connection body connecting the operation unit with the strain body, the connection body being at least partially deformed by the force applied to the operation unit;
at least four strain gauges respectively gauging a deformation of the strain body;
an operation force calculator calculating the force applied to the operation unit based on a gauged strain by each of the at least four strain gauges; and
a stay attached to the operation unit, wherein
a wide portion of the operation unit is disposed along a periphery of the operation surface and protrudes in a direction that is generally in parallel with the operation surface,
a narrow portion of the operation unit is fixedly disposed on the stay, and
the wide portion is positioned on a side of the operation unit adjacent to the operation surface, and the narrow portion is positioned away from the operation surface on an opposite side of the operation unit relative to the operation surface and the wide portion.

2. The operation input device of claim 1, wherein
the operation unit has a sidewall that narrows from the wide portion toward the narrow portion.

3. The operation input device of claim 1, wherein
the connection body is formed from a flat spring.

4. The operation input device of claim 1, wherein
the operation unit has a cylindrical shape.
